(19) United States
(12) Patent Application Publication
(10) Pub. No.: US 2015/0189863 A1
(43) Pub. Date: Jul. 9, 2015

(54) BAIT HOLDER HOOK

(71) Applicant: USA HOOKS GP, Spring, TX (US)

(72) Inventors: Martin Stanaland, Nacogdoches, TX (US); John DeBoer, Spring, TX (US)

(21) Appl. No.: 14/416,059

(22) PCT Filed: Sep. 22, 2013
(86) PCT No.: PCT/US13/61097

§ 371 Date: Jan. 20, 2015

Related U.S. Application Data
(60) Provisional application No. 61/706,683, filed on Sep. 27, 2012.
(60) Provisional application No. 61/711,202, filed on Oct. 8, 2012.

(51) Int. Cl. A01K 83/06; A01K 91/00; A01K 87/00

(52) U.S. Cl. CPC A01K 83/06; A01K 87/007; A01K 91/00

(57) ABSTRACT

A bait holder hook apparatus comprising a coupler zone configured to couple the apparatus with an external element; a first segment linked with the coupler zone, and ending in a bait end; and a second segment associated with the first segment, and ending in a hook end. In aspects, the bait end may comprise a protrusion configured for insertion into a bait.

### BACKGROUND OF THE DISCLOSURE

1. Field of the Disclosure

Embodiments disclosed herein relate generally to fishing gear. Particular embodiments disclosed herein relate to a bait holder apparatus. Other embodiments pertain to a combination bait holder fish hook apparatus configured for attachment of live bait in proximity to a fish hook without penetration of the live bait with the fish hook.

2. Background

In the modern world fishing continues to be a very popular sport, as anglers enjoy the challenge of catching fish for sport and enjoying a fresh meal. Although fishing gear technology has increased in sophistication for the betterment of the sport, simple concepts remain prevalent as sophistication unwittingly results in complication, high expense, etc. Such aspects include conventional fish hooks, which are variously configured, with the size, shape, etc. often dependent upon the type of fish sought after, but generally inclusive of at least one barbed end for hooking bait (and resultantly, a fish).

Unfortunately popular fish hooks include those that kill or significantly injure live bait when attached therewith, as the bait is typically impaled or penetrated in the body or the head. When not killed instantly, live bait often dies shortly thereafter as the bait is pulled through the water (such as by reeling or trolling) as a result of amplification or enlargement of the wound. Alas, dead bait is significantly unattractive and/or unappealing to fish. Also, even if alive, the bait remains undesirably susceptible to being taken by a nibbling fish without the fish hooked by the hook.

Current methods of baiting a fishhook wherein the bait is impaled with a barb or pointed end of the hook are undesirably slow, tedious, repulsive, wasteful, dangerous, and in extreme situations, life or limb threatening. Further problematic is that some anglers do not understand the necessity to injure or kill the bait. To this end, just the thought of intentional impalement of live bait is enough to dissuade some of the general public from enjoying or trying fishing altogether.

Impalement of live bait results in external bleeding and in some cases, infected guts that squirt out. Although death is unavoidable, instantaneous death is wasteful as live bait is expensive. In addition, these baiting methods take too long. For example, consider when fishing where two poles are used. In one example, one pole might jerk from a bite or nibble, but a user is busy trying to bait the hook on the second pole (trying not to kill it), which then results in “missing” the hit on the first pole.

Impalement of bait is also a significant safety concern, as the hook sometimes stabs a hand or finger rather than the bait. If one is a diabetic or has a compromised immune system, the process of stabbing bait may be life or limb threatening, as conventional baiting may result in inadvertent injection of germs (or virus, bacteria, water-born diseases, etc.) into a user.

What is needed is a better way of attaching bait to a fish hook, and a fish hook apparatus that provides the same. There is a tremendous need in the art for a fish hook apparatus that is safe and easy to use, and allows bait to be quickly and cleanly attached thereto, but is also economical and practicable. It is desirable to provide fishing gear that provides improved user safety and user performance.

### SUMMARY

Embodiments disclosed herein provide for a bait holder hook apparatus that may include a coupler zone configured to couple the apparatus with an external element; a first segment linked with the coupler zone, and ending in a bait end; and a second segment associated with the first segment, and ending in a hook end. The coupler zone may include an eyelet that is part of a coil spring. The first segment may include a first elongated portion. The second segment may include a second elongated portion and a second arcuate portion.

At least one of the first segment, the second segment, and combinations thereof, may be biased toward a first position. The first position may include a first contact point of the first segment engaged with a second contact point of the second segment. The bait end may include a protrusion. The protrusion may be rounded. The apparatus may include a bait platform. In aspects, the bait platform may include one of a channel and a notch configured to engage with the protrusion in the first position.

The first segment may include a first bend. The second segment may include a second bend. The first segment and the second segment may be configured to form a cross-over. The coupler zone comprises a coil spring of at least 2 turns, wherein a first spring end links to the first segment, and wherein a second spring end links to the second segment. A live bait may be attached to the bait end. The hook end and the bait end may be biased toward each other.

Embodiments of the disclosure pertain to a method of baiting a fish hook apparatus that may include the steps of coupling the fish hook apparatus to a fish line, and attaching a live bait to the bait end. The fish hook apparatus may include a first segment ending in a bait end; and a second segment ending in a hook end. The method may include pressing a first portion of the first segment and a second portion of the second segment together in order to move the apparatus from a first position to a second position. In aspects, a live bait is attached to the bait end when the apparatus is in the second position.

Yet other embodiments of the disclosure pertain to a fishing system that may include a fishing rod comprising a fishing line, and configured for casting the fishing line a fish hook; and a live bait attached to the bait end. The fish hook may include a coupler zone configured to couple the hook with the fishing line; a first segment linked with the coupler zone, and ending in a bait end; and a second segment associated with the first segment, and ending in a hook end.

The first segment may include a first elongated portion. The second segment may include a second elongated portion and a second arcuate portion. At least one of the first segment, the second segment, and combinations thereof, may be biased toward a first position. The first position may include a first contact point of the first segment engaged with a second contact point of the second segment. The bait end may include a protrusion. The bait may be attached to the bait end with a bait end protrusion internal of the bait.

Embodiments of the disclosure pertain to a bait holder hook apparatus that may include a coupler zone configured to couple the apparatus with an external element; a first segment linked with the coupler zone, and ending in a bait end; and a second segment associated with the first segment, and ending in a hook end.

The coupler zone may include an eyelet that is part of a coil spring.

The first segment may include a first elongated portion. The second segment may include a second elongated portion. The second segment may include a second arcuate portion. In aspects, at least one of the first segment, the second segment, and combinations thereof, may be biased toward a first position. In other aspects, the first position may include a first contact point of the first segment engaged with a second contact point of the second segment.

The bait end may include a first material. The hook end may include a second material different from the first material. The first material and the second material may be the same. The first material and the second material may be different.

The apparatus may include an adhesive.

Components of the apparatus may be integral to one another.

The second segment may include a bait platform. In aspects, the bait platform may be engaged with the bait end in a first position. In aspects, the bait platform may be defined by a planar. In other aspects, at least a portion of the bait end may reside on a first side of the planar in the first position. In yet other aspects, the entire bait end may reside on a second side of the planar in the second position.

The bait end may include a protrusion. The protrusion may be rounded.

The bait platform may include one of a channel and a notch. The channel and/or the notice may be configured to engage with the protrusion in the first position.

The first segment may include a first bend. The second segment may include a second bend. The first segment and the second segment may be configured to form a cross-over.

The coupler zone may include a coil spring of at least 2 turns. In aspects, a first spring end may link to the first segment. In aspects, a second spring end may link to the second segment.

A bait may be attached to the bait end. The bait may be live or artificial. The bait may be attached to the bait end with a bait end protrusion internal of the bait. The bait may be attached to the bait end by oral insertion. The bait may include a minnow. The apparatus may be coupled with a fishing line.

The hook end and the bait end may be biased toward each other.

Other embodiments disclosed herein pertain to a method of baiting a fish hook apparatus that may include coupling the fish hook apparatus to a fish line, the fish hook apparatus having a first segment ending in a bait end; and a second segment ending in a hook end. The method may include attaching a live bait to the bait end.

The method may include pressing a first portion of the first segment and a second portion of the second segment together in order to move the apparatus from a first position to a second position. In aspects, the live bait may be attached to the bait end when the apparatus is in the second position.

Yet other embodiments disclosed herein pertain to a fishing system that may include a user; a fishing line; a fish hook apparatus having a coupler zone configured to couple the apparatus with the fishing line; a first segment linked with the coupler zone, and ending in a bait end; and a second segment associated with the first segment, and ending in a hook end; and a bait attached to the bait end.

A fishing rod may be configured for casting the fishing line. The bait may include a live fish. The coupler zone may include an eyelet that is part of a coil spring. The first segment may include a first elongated portion. The second segment may include a second elongated portion. The first and/or second segment may include an arcuate portion. At least one of the first segment, the second segment, and combinations thereof, may be biased toward a first position. The first position may include a first contact point of the first segment engaged with a second contact point of the second segment.

The bait end may include a first material. The hook end may include a second material. The first material and the second material may be different. The apparatus may include an adhesive.

In aspects, all components of the apparatus may be integral to one another. The second segment may include a bait platform. The bait platform may be engaged with the bait end in a first position.

The bait platform may be defined by a planar. In aspects, at least a portion of the bait end may reside on a first side of the planar in the first position. In aspects, the entire bait end may reside on a second side of the planar in the second position.

The bait end may include a protrusion. The protrusion may be rounded. The bait platform may include one of a channel and a notch configured to engage with the protrusion in the first position.

The first segment may include a first bend. The second segment may include a second bend. The first segment and the second segment may be configured to form a cross-over.

The coupler zone may include a coil spring of at least 2 turns. In aspects, a first spring end may link and/or be associated with the first segment. In aspects, a second spring end may link and/or be associated with the second segment.

A bait may be attached to the bait end. The bait may be live or artificial. The bait may be attached to the bait end with a bait end protrusion internal of the bait. The bait may be attached to the bait end by oral insertion. The bait may include a minnow.

The apparatus may be coupled with a fishing line.

The hook end and the bait end may be biased toward each other. In aspects, wherein pressing a first portion of the first segment and a second portion of the second segment together in moves the fish hook apparatus from a first position to a second position.

Live bait may be attached to the bait end when the fish hook apparatus is in the second position.

Other aspects and advantages of the disclosure will be apparent from the following description and the appended claims.

### BRIEF DESCRIPTION OF DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIGS. 1A and 1B show longitudinal side views of a bait holder apparatus, in accordance with embodiments of the present disclosure.

FIGS. 2A and 2B show a side lateral view, and an overhead view, respectively, a bait end protrusion of a bait holder apparatus, in accordance with embodiments of the present disclosure. FIG. 2C shows a view of a bait end protrusion with an inner spring mechanism

FIGS. 3A, 3B, 3C, 3H, and 31 show longitudinal side views of various bait holder apparatuses configured with a cross-over and a bait platform, in accordance with embodiments of the present disclosure.

FIGS. 3D and 3F show longitudinal side views of bait holder apparatuses with various bait end configurations, in accordance with embodiments of the present disclosure.

FIG. 3E shows an overhead view a bait platform of a bait holder apparatus, in accordance with embodiments of the present disclosure.

FIG. 3G shows a longitudinal side view of a bait holder apparatus moved to a second position, in accordance with embodiments of the present disclosure.

FIGS. 4A, 4B, 4C, 4D, 4E, 4F, 4G, and 4H show longitudinal views of various bait holder apparatus in a one piece configuration, in accordance with embodiments of the present disclosure.

FIGS. 5A, 5B, 5C, 5D, 5E, 5F, and 5G show longitudinal side views of various bait holder apparatus with one or more bait end configurations, in accordance with embodiments of the present disclosure.

FIGS. 6A, 6B, 6C, 6D, and 6E show various views of a bait holder apparatus with various multi-hook configurations, in accordance with embodiments of the present disclosure.

### DETAILED DESCRIPTION

Specific embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the disclosure. However, it will be apparent to one of ordinary skill in the art that the embodiments disclosed herein may be practiced without these specific details. In other instances, well-known features have not been described in detail to avoid unnecessarily complicating the description.

In addition, directional terms, such as “above,” “below,” “upper,” “lower,” “front,” “back,” etc., are used for convenience in referring to the accompanying drawings. As such, these indicator words refer to general direction and/or orientation, and are only intended for illustrative purposes only, and the terms are not meant to limit the disclosure.

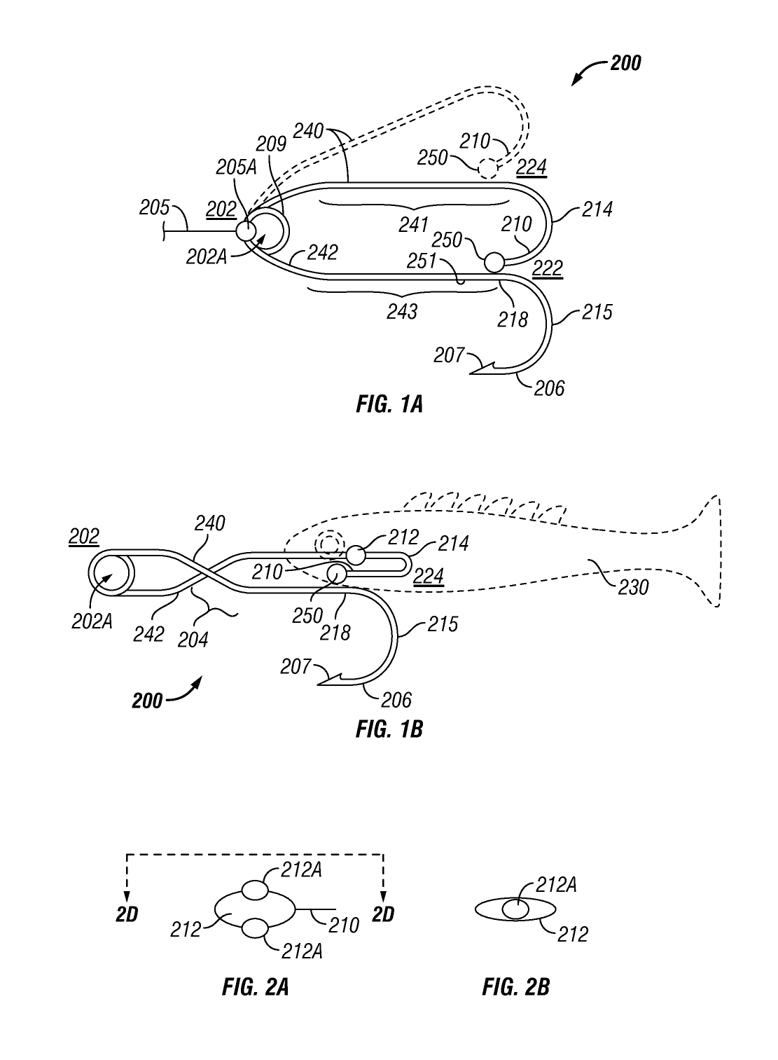

Referring now to FIGS. 1A and 1B together, side views of a bait holder apparatus, and a bait holder apparatus configured with a cross-over region and a bait attached therewith, respectively, according to embodiments disclosed herein, are shown. In the general sense, the bait holder hook apparatus 200 of the present disclosure may include a coupler zone 202, which may be configured for coupling or attachment of the apparatus 200 with an external element 205.

The coupler zone 202 may include an eyelet 202A or other suitable configuration for coupling. The external element 205 may be, for example, a leader, a fishing line, and combinations thereof. In aspects, the leader may be constituted of a length of fishing line. The external element 205 may be a conventional fishing line rigged through a standard rod and reel (not shown) in any suitable manner known in the art, whereby the apparatus 200 may be cast out and selectively reeled in.

However, the present invention can be used with any type of fishing equipment and/or any type of fishing line, and can be secured therewith in any suitable manner known in the art. It is within the ambit of the disclosure to utilize virtually any type of lure, including all forms of live bait (e.g., insects, fish, etc.), as well as any suitable artificial bait (e.g., manmade lures, etc.), food and food-type products (e.g., vegetables, odorous pastes, etc.).

In accordance with the disclosure, the bait 230 may be a live fish, such as a minnow(s), shad, etc. The bait 230 may be other live creatures, such as crawfish, frogs, insects (e.g., crickets), worms, shrimp, etc., or any type of bait kept alive prior to baiting. Other baits include meat, chum, or even small mammals such as mice and other natural live. The bait 230 may be dead and/or artificial. Artificial bait may include, for example, plastic worms, crawfish, grubs, snakes, and the like. In general, the textures of such baits are rather soft and of uniform texture. Frequently the baits are made to be very soft to more closely simulate a natural or living creature. The bait 230 may be suitable for freshwater fishing, saltwater fishing, and/or both. Other attractants, such as bait scent, may be provided or otherwise placed as desired on the fish hook apparatus 200.

An end 205A of the external element 205 may be fed through the coupler zone 202 and/or eyelet 202A, and then tied in a knot or other manner that results in secured coupling between the apparatus 200 and the external element 205. In embodiments, the eyelet 202A may be resultant or configured from a bias member 209. The bias member 209 may be a spring coil, which may have a number of turns or wire wraps. For example, the bias member 209 may have in the range of about 0 to about 10 turns. In other embodiments, the number of turns is about 1 to about 5. In yet other embodiments the number of turns is between about 2 to 3.

The apparatus 200 may include a first bias member end 209A that may lead or link to the first segment 240. Similarly, there may be a second bias member end 209B that may lead or link to the second segment 242.

The coupler zone 202 and/or other portions of the apparatus 200 may be flexible or otherwise movable. Flexibility may result from use of the bias member 209. However, the coupler zone 202 and/or other portions of the apparatus 200 may be rigid, sturdy, and otherwise durable.

The bias member 209 may urge the apparatus 200 to a first potion 222. The first position 222 may be a closed position. In aspects, the bias member 209 may vary in size, strength, etc. The size and strength of the bias member 209 may determine the flexibility or firmness of the apparatus 200, segments 240, 242, and so forth. Flexibility of the apparatus 200 may result in portions of a first segment 240 and a second segment 242 being able to be pressed together (such as from a user's squeezing motion), such that at the same time a bait end 210 and a hook end 206 may be moved apart (see FIG. 1B).

As such, squeezing or urging of portions of the first segment 240 and the second segment 242 together may result in the apparatus 200 being moved from the first position 222 to the second position 224. In other aspects, moving the first segment 240 and the second segment 242 apart from each other may result in the apparatus being moved from the first position 222 to the second position 224 (see FIG. 1A).

When the segments 240, 242 are released, the bias member 209 may then urge the apparatus 200 to return or move to the first position 222. In embodiments, the bait 230 may be retained between the bait end 210 and the hook end 206 without the bait 230 being impaled.

As such, the apparatus 200 may include the first segment 240, which may be associated or linked with the coupler zone 202, and which may end or terminate in a bait end 210. The apparatus 200 may include the second segment 242, which may be associated or linked with the coupler zone 202 and/or the first segment 240. The second segment 242 may end or terminate in a hook end 206. The hook end 206 may include a barb 207.

The use of the barb 207 on the hook end 206 may help ensure fish have more difficulty (if not impossibility) from disengagement off the hook end 206. However, embodiments disclosed herein may include use of barbless hooks (mandatory in some fishing areas). The use of barbless hooks may allow an angler to easily remove the hook and release the fish without harming it, comply with regulations, etc.

The first segment 240 may have a first elongated portion 241, and the first segment 240 may include a first arcuate portion 214. Similarly, the second segment 242 may include a second elongated portion 243, and the second segment 242 may include a second arcuate portion 215. In embodiments, at least one of the first segment 240, the second segment 242, and combinations thereof, may be biased toward the first position 222. The first position 222 may be a closed position that may include a first contact point 250 of the first segment 240 engaged with or touching a second contact point 251 of the second segment 242. The apparatus 200 may have at least a second position 224. The second position 224 may be an open position that includes the contact points 250 and 251 no longer engaged with or touching each other.

The figures illustrate the apparatus 200 may be in the second or open position 224 when no bait is present, and/or the apparatus 200 may be in the first or closed position 222 when no bait is present. In aspects, the apparatus 200 may be in the second or open position 224 when the bait 230 is attached with the apparatus 200 (see FIG. 1B).

The apparatus 200 may be made of or from any number of materials of construction. In this sense, any of the features or components of the apparatus 200 may be made of or from any number of materials of construction. The apparatus 200 may be a wire or wire material with a thickness or diameter in the range of about 0.02 to about 0.1 inches. However, the size, dimensions, etc. of the apparatus 200 are not meant to be limited, as the apparatus 200 may be different sizes, dimensions, etc. dependent upon whatever fishing endeavor is undertaken (be it fishing for 16′ sharks or 4″ perch).

Thus, the apparatus 200 may be formed of any suitable material and variously dimensioned consistent with the type of fish the apparatus 200 may be used to fish with. It is within the scope of the disclosure to utilize any type of fish hook end 206 configured for any type of fish, as would be apparent to one of skill in the art.

The scope of the disclosure is not limited to an apparatus that is of a single material. In embodiments, the bait end 210 may be a first material 253, and the hook end 206 may be a second material 254. In some embodiments, the first material 253 and the second material 254 may be the same, while in other embodiments the first material 253 and the second material 254 may be different.

In embodiments, the first material 253 may include rubber, metal, metal alloys, and combinations thereof. In embodiments, the second material 254 may include rubber, metal, metal alloys, and combinations thereof. The apparatus 200 may be made of resilient stainless steel wire, and sufficiently thin so as to be substantially invisible to fish when in used in water. The apparatus 200 may be made from a first material, such as a rustproof metal, rustproof plastic, combinations thereof, etc.

The apparatus 200 may be made from metal such as rod, bar, wire or from flat stock. However, alloys, plastics, or any other suitable material or stock in a variety of geometrical shapes such as round, square or rectangular, may be used for construction. The apparatus 200 may be constructed in a wide variety of sizes for use with various bait when seeking particular target fish without departing from the scope of this disclosure. The apparatus may be made by forming, bending, casting, machining, stamping, laser cutting, water jet cutting, molding, and other conventional fabrication techniques. The apparatus 200 may aptly be formed from known manufacturing and fabrication processes, such as those used by Addya Fish Hooks & Tackles or Eagle Claw.

In accordance with the disclosure, the hook size, number of hooks, number of barbs, and style are not meant to be limited, other than as how claimed. Moreover, other configurations, such as a weedless configuration, may be used. Thus, the apparatus 200 may include a weedless configuration like that presented in U.S. Pat. Nos. 2,569,119; 4,924,618; and 6,560,917, the disclosure of each being incorporated herein in its entirety for all purposes. In some embodiments, the apparatus 200 may include a lure/spoon configuration, such as the lure and/or spoon configuration presented in U.S. Pat. Nos. 4,219,956 and 5,511,338, the disclosure of each being incorporated herein in its entirety for all purposes.

In aspects, the apparatus 200, including its features and components, is a single, integral apparatus 200, such as entirely from the bait end 210 to the hook end 206. However, in other aspects, the apparatus may be a modular system, whereby various features and components are separable from one other, such as by threadable features, quick disconnects, insertions, and the like. For example, the bait end 210 may be removable (e.g., separable, etc.) from the apparatus 200 such that a second bait end 210A may be switched therewith and connected to the apparatus 200. Thus, either of the segments 240, 242 may include an attachment mechanism (or comparable disconnect), such as an opening or hole, matable with a portion of the bait end 210 and/or hook end 206, respectively.

This provides a user tremendous flexibility because not all live bait(s) are the same, and there may be times where different size features are necessary for attachment of the bait 230. Analogously, the hook end 206 may be removable from the apparatus 200 such that a second hook end 206A may be switched therewith and connected to the apparatus 200. This provides a user tremendous flexibility because not all game fish are the same, and there may be times where different size fish are sought after by the user (e.g., large mouth bass versus small mouth bass). Thus, the apparatus 200 may utilize or otherwise be configured with variety of hook sizes such as those ranging in size from smaller fresh water trout hooks (or catfish hooks, bass hooks, pike hooks, etc.) to larger hook sizes suitable for catching saltwater fish such as cod, striped bass, marlin, shark, tuna, etc. In embodiments, the second segment 242 and/or hook end 206 may include at least a second hook end (not shown).

In embodiments, the fish hook apparatus 200 may be colored. In some embodiments, parts of the fish hook apparatus 200 may be colored. The use of color may provide camouflage for the apparatus 200 while it moves through the water, thus aiding appearance to fish.

The apparatus 200 may include an adhesive 255 disposed thereon. The adhesive 255 may be, for example, double sided tape, with a removable film that upon removal exposes a sticky part. The adhesive may be water soluble and/or biodegradable. The adhesive 255 may be disposed on the first segment 240 and/or second segment 242. The adhesive 255 may be disposed on the bait end 210 and/or the hook end 206. The adhesive 255 may be disposed on the protrusion(s) 212. The adhesive 255 may provide the apparatus 200 with the ability to stabilize the position of the bait 230 on the adhesive 255. However, the adhesive 255 may be weak enough such that the bait 230 may still be readily removed, such as when a user desires to switch bait.

The second segment 242 may include a bait platform 218. ‘Platform’ in this sense may be used to denote a part of the apparatus 200 intended for the bait 230 to contact, and in a general instance, albeit not necessary, the bait 230 may receive some stability (such as by way of support) from such contact. However, the configuration of the bait platform 218 is not meant to be limited by the term. Thus, the bait platform 218 may be uniform, comparable, identical, etc. in configuration (e.g., thickness, material, etc.) as the rest of the second segment 242. As shown in the Figures, the bait platform 218 may be part of the second segment 242 that is between the second arcuate 215 and the coupler zone 202.

Still, the bait platform 218 may take on a number of configurations that differentiate the bait platform 218 from the rest of the second segment 242. For example, the bait platform 218 may have a difference in thickness from the second segment 242. The bait platform 218 may have a partially flat surface.

In embodiments, the bait platform 218 may be engaged with the bait end 210 in the first position 222. In embodiments, the bait platform 218 may be disengaged with the bait end 218 in the second position 224.

The bait platform 218 may be defined by a planar (e.g., planar reference) 257. In this sense, at least a portion 210A of the bait end 210 may reside on a first side 257A of the planar 257 in the first position 222. Relatedly, the entire bait end 210 may reside on a second side 257B of the planar 257 in the second position 224.

The bait end 210 and/or protrusion 212 may include a barb. In embodiments, the protrusion 212 may include a bait end barb 219. The protrusion 212 may provide a ‘cam’ action in conjunction with the bait 230. That is, in some embodiments, the protrusion 212 may be inserted orally to the bait 230, and then the bait 230 and/or the apparatus 200 may be turned or twisted, such that the orientation of the protrusion 212 in the bait 230 results in more tension and resistance that keeps the bait thereon. For example, more tension may be applied against the roof and lower part of the bait mouth, and while possibly uncomfortable, the tension force is hardly fatal.

Referring briefly to FIGS. 2A and 2B, a side lateral view, and an overhead view, respectively, of a protrusion end useable with a bait holder apparatus, according to embodiments disclosed herein, are shown. The bait end (e.g., 210, FIG. 1A) may include a protrusion 212 disposed thereon or associated therewith. In some embodiments, the protrusion 212 may be rounded, such as spherical, ovular, elliptical, etc., while in other embodiments the protrusion 212 may be partially rounded, such as partially spherical, partially ovular, etc. The protrusion 212 may be slightly rounded, slightly flattened, and combinations thereof. FIG. 2C illustrates the protrusion may be configured with an internal spring mechanism (or comparable).

The protrusion 212 may have additional protrusions 212A disposed thereon and/or associated therewith. The protrusion(s) 212A may be firm and fixed in situ. The protrusion(s) 212A may be compressible. The protrusion(s) 212A may be movable within or internal to the protrusion 212 analogous to a blade of a switch blade. That is, one or more of the protrusions 212A may reside out of the way while the protrusion 212 is inserted into the bait 230, where upon doing so, the protrusion 212A may be released and into engagement with an inner surface of the bait 230. The protrusion 212 may be a swellable material. For example, the protrusion may be inserted into the bait 230, at which point the swellable material may be activated and swells to a larger size.

Referring again to FIGS. 1A and 1B together, the bait platform 218 may include a channel (or notch, groove, depression, etc.) 216 configured to engage with the protrusion 212, such as in the first position 222. The channel 216 may be movingly separable from the protrusion 212, such as when the apparatus 200 is moved to the second position 224 (e.g., out of the first position).

The first segment 240 may include a first disconnect 258. The second segment 242 comprises a second disconnect 259. The first segment 240 may include a first bend 260. The second segment 242 may include a second bend 262. In embodiments, the first segment 240 and the second segment 242 may be configured to form or include a cross-over (or cross-over zone, cross-over region, etc.) 204.

The bait 230 may be attached to the bait end 210 with the protrusion 212 internal to the bait 230. In embodiments, the bait 230 may be attached to the bait end 210 by oral insertion of at least a portion of the bait end 210 into the bait 230. At least a portion 230A of the bait 230 may contact at least a corresponding portion 242A of the second segment 242. The second segment 242 and/or hook end 206 may include a second hook end 206A.

The hook end 206 and the bait end 210 may be biased toward each other. A first bait end portion 210A of the bait end 210 and a first hook end portion 206A of the hook end 206 may be shiftably coupled together. The first segment 240 may include a first elongated shaft 266. The second segment 242 may include a second elongated shaft 267. The second elongated shaft 267 and the hook end 206 may be separated by a second bend (or second arcuate portion) 208.

The second segment 242 may include a notch (e.g., channel, detent, groove, recess, etc.) 216. The notch may include an opening 216A. The notch 216 may be a narrow slot within the bait platform 218. The size of the notch 216 may be such that insertion of the protrusion 212 therein may occur.

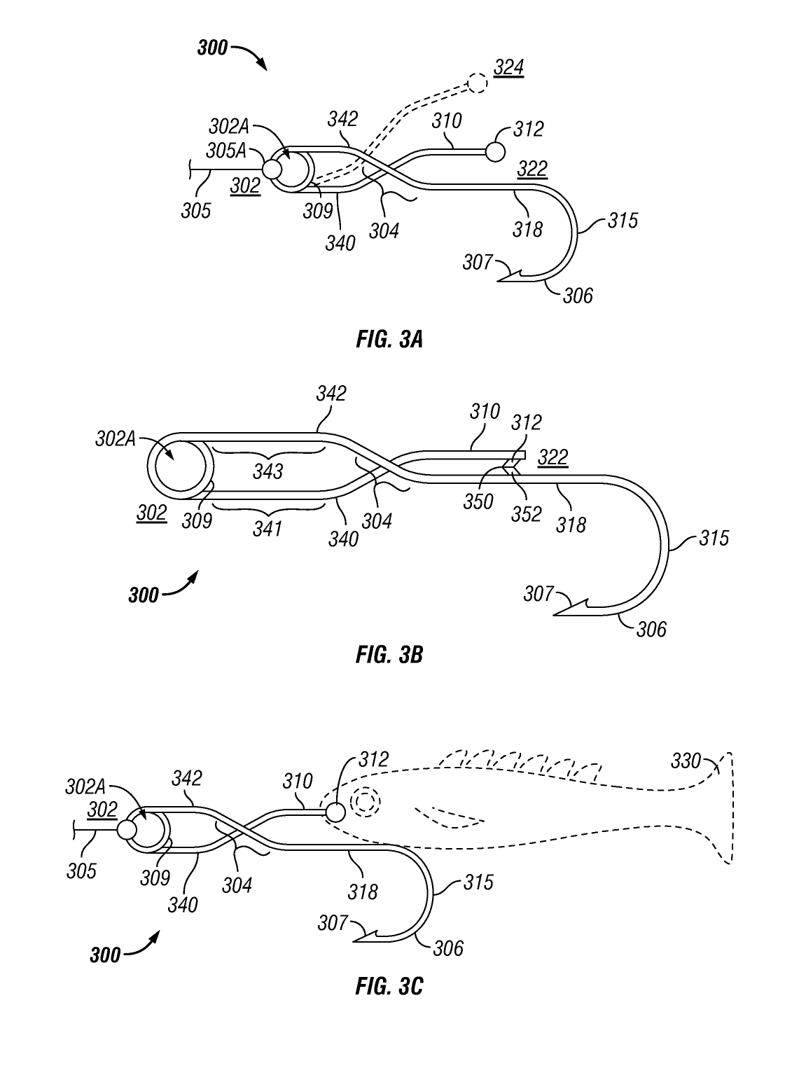

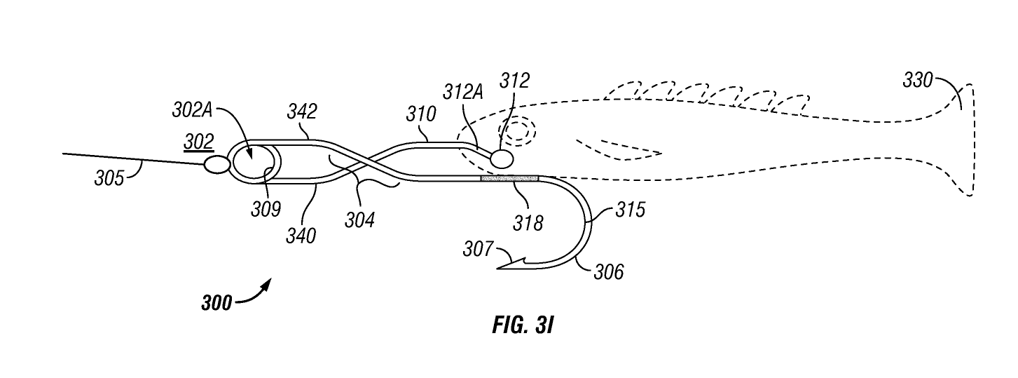

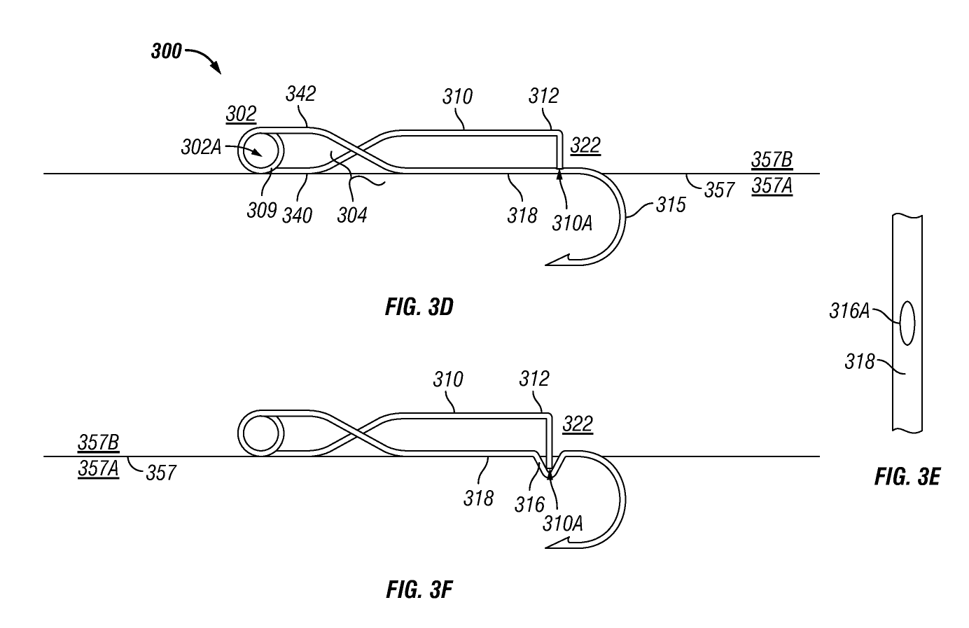

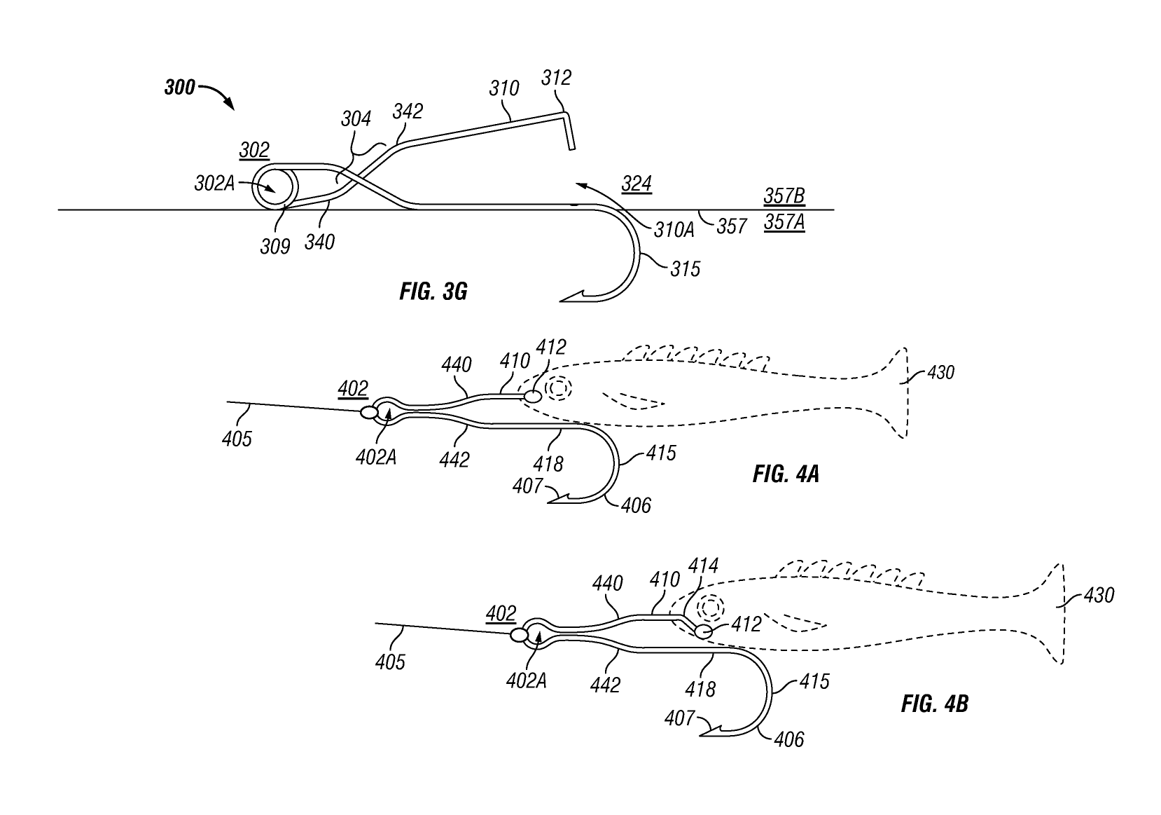

Referring now to FIGS. 3A, 3B, 3C, 3D, 3E, 3F, and 3G together, side views of various bait holder apparatuses configured with a cross-over and a bait platform, according to embodiments disclosed herein, are shown. Like the fish hook apparatus 200 previously described, a bait holder apparatus 300 may be usable for aspects disclosed herein. As such, the bait holder apparatus 300 may include similar components and materials of construction as described previously, such that apparatus 300 may be similar to others described herein; however, apparatus 300 and others described herein are not necessarily identical.

FIGS. 3A and 3B together show, in the general sense, the bait holder hook apparatus 300 of the present disclosure may include a coupler zone 302, which may be configured for coupling or attachment of the apparatus 300 with an external element 305. The coupler zone 302 may include an eyelet 302A or other suitable configuration for coupling. The external element 305 may be, for example, a leader, a fishing line, and combinations thereof. In aspects, the leader may be constituted of a length of fishing line.

The external element 305 may be a conventional fishing line rigged through a standard rod and reel (not shown) in any suitable manner known in the art, whereby the apparatus 300 may be cast out and selectively reeled in. Accordingly, embodiments of the disclosure may pertain to use of the apparatus 300 and any type of fishing equipment utilizing any type of fishing line. It is also within the scope of the disclosure that the apparatus 300 may be used with any type of bait or lure, including all forms of live bait (e.g., insects, fish, etc.), any suitable artificial bait (e.g., manmade lures, etc.), and food and food-type products (e.g., vegetables, odorous pastes, etc.).

An end 305A of the external element 305 may be fed through the coupler zone 302 and/or eyelet 302A, and then tied in a knot or other manner that results in secured coupling between the apparatus 300 and the external element 305. In embodiments, the eyelet 302A may be resultant or configured from a bias member 309. The bias member 309 may be a spring coil, which may have a number of turns or wire wraps. For example, the bias member 309 may have in the range of about 0 to about 10 turns. In other embodiments, the number of turns is about 1 to about 5. In yet other embodiments the number of turns is between about 2 to 3.

The coupler zone 302 and/or other portions of the apparatus 300 may be flexible or otherwise movable. Flexibility may result from use of the bias member 309. However, the coupler zone 302 and/or other portions of the apparatus 300 may be rigid, sturdy, and otherwise durable.

The bias member 309 may urge the apparatus 300 to a first potion 222. The first position 322 may be a closed position. In aspects, the bias member 309 may vary in size, strength, etc. The size and strength of the bias member 309 may determine the flexibility or firmness of the apparatus 300, segments 340, 342, and so forth. Flexibility of the apparatus 300 may result in portions of a first segment 340 and a second segment 342 being able to be pressed together (such as from a user squeezing), such that at the same time a bait end 310 and a hook end 306 may be moved apart.

As such, squeezing or urging of portions of the first segment 340 and the second segment 342 together may result in the apparatus 300 being moved from the first position 322 to the second position 324. In other aspects, moving the first segment 340 and the second segment 342 apart from each other may result in the apparatus being moved from the first position 322 to the second position 324. When the segments 340, 342 are released, the biasing member 309 may then continue to urge the apparatus 300 to the first or closed position 322.

As such, the apparatus 300 may include the first segment 340, which may be associated or linked with the coupler zone 302, and which may end or terminate in a bait end 310. The apparatus 300 may include the second segment 342, which may be associated or linked with the coupler zone 302 and/or the first segment 340. The second segment 342 may end or terminate in a hook end 306. The hook end 306 may include a barb 307.

The use of the barb 307 on the hook end 306 may help ensure fish have more difficulty (if not impossibility) from disengagement off the hook end 306. However, embodiments disclosed herein may include use of barbless hooks (mandatory in some fishing areas). The use of barbless hooks may allow an angler to easily remove the hook and release the fish without harming it, comply with regulations, etc.

The first segment 340 may have a first elongated portion 341, and the first segment 340 may include a first arcuate portion (not shown). Similarly, the second segment 342 may include a second elongated portion 343. The second segment 242 may include a second arcuate portion 315. In embodiments, at least one of the first segment 340, the second segment 342, and combinations thereof, may be biased toward the first position 322.

The first position 322 may be a closed position that may include a first contact point 350 of the first segment 340 engaged with or touching a second contact point 351 of the second segment 342. The apparatus 300 may have at least a second position 324. The second position 324 may be an open position that includes the contact points 350 and 351 no longer engaged with or touching each other.

The figures illustrate the apparatus 300 may be in the second or open position 324 when no bait is present, and/or the apparatus 300 may be in the first or closed position 322 when no bait is present. In aspects, the apparatus 300 may be in the second or open position 324 when the bait 330 is attached with the apparatus 300 (see FIG. 2C).

The apparatus 300 may be made of or from any number of materials of construction. In this sense, any of the features or components of the apparatus 300 may be made of or from any number of materials of construction. The apparatus 300 may be a wire or wire material with a thickness or diameter in the range of about 0.02 to about 0.1 inches. However, the size, dimensions, etc. of the apparatus 300 are not meant to be limited, as the apparatus 300 may be different sizes, dimensions, etc. dependent upon whatever fishing endeavor is undertaken (be it fishing for 16′ sharks or 4″ perch).

Thus, the apparatus 300 may be formed of any suitable material and variously dimensioned consistent with the type of fish the apparatus 300 may be used to fish with. It is within the scope of the disclosure to utilize any type of fish hook end 306 configured for any type of fish, as would be apparent to one of skill in the art.

The scope of the disclosure is not limited to an apparatus that is of a single material. In embodiments, the bait end 310 may be a first material 353, and the hook end 306 may be a second material 354. In some embodiments, the first material 353 and the second material 354 may be the same, while in other embodiments the first material 353 and the second material 354 may be different.

In embodiments, the first material 353 may include rubber, metal, metal alloys, and combinations thereof. In embodiments, the second material 354 may include rubber, metal, metal alloys, and combinations thereof. The apparatus 300 may be made of resilient stainless steel wire, and sufficiently thin so as to be substantially invisible to fish when in used in water. The apparatus 300 may be made from a first material, such as a rustproof metal, rustproof plastic, combinations thereof, etc.

In accordance with the disclosure, the hook size, number of hooks, number of barbs, and style are not meant to be limited, other than as how claimed. Moreover, other configurations, such as a weedless configuration as described herein, may be used. In some embodiments, the apparatus 300 may include a lure/spoon configuration, such as the lure and/or spoon configuration as described herein.

In aspects, the apparatus 300, including its features and components, is a single, integral apparatus 300, such as entirely from the bait end 310 to the hook end 306. However, in other aspects, the apparatus may be a modular system, whereby various features and components are separable from one other, such as by threadable features, quick disconnects, insertions, and the like. For example, the bait end 310 may be removable (e.g., separable, etc.) from the apparatus 300 such that a second bait end 310A may be switched therewith and connected to the apparatus 300. Thus, either of the segments 340, 342 may include an attachment mechanism (or comparable disconnect), such as an opening or hole, matable with a portion of the bait end 310 and/or hook end 306, respectively.

This provides a user tremendous flexibility because not all live bait(s) are the same, and there may be times where different size features are necessary for attachment of the bait 330. Analogously, the hook end 306 may be removable from the apparatus 300 such that a second hook end 306A may be switched therewith and connected to the apparatus 300. This provides a user tremendous flexibility because not all game fish are the same, and there may be times where different size fish are sought after by the user (e.g., large mouth bass versus small mouth bass). Thus, the apparatus 300 may utilize or otherwise be configured with variety of hook sizes such as those ranging in size from smaller fresh water trout hooks (or catfish hooks, bass hooks, pike hooks, etc.) to larger hook sizes suitable for catching saltwater fish such as cod, striped bass, marlin, shark, tuna, etc.

The apparatus 300 may be made from metal such as rod, bar, wire or from flat stock. However, alloys, plastics, or any other suitable material or stock in a variety of geometrical shapes such as round, square or rectangular, may be used for construction. The apparatus 300 may be constructed in a wide variety of sizes for use with various bait when seeking particular target fish without departing from the scope of this disclosure. The apparatus 300 may be made by or from conventional fabrication techniques described herein.

In embodiments, the fish hook apparatus 300 may be colored. In some embodiments, parts of the fish hook apparatus 300 may be colored. The use of color may provide camouflage for the apparatus 300 while it moves through the water, thus aiding appearance to fish. The apparatus 300 may include an adhesive 355 disposed thereon in accordance with embodiments described herein. The adhesive 355 may provide the apparatus 300 with the ability to stabilize the position of the bait 330 on the adhesive 355. However, the adhesive 355 may be weak enough such that the bait 330 may still be readily removed, such as when a user desires to switch bait.

The second segment 342 may include a bait platform 318. ‘Platform’ in this sense is used to denote a part of the apparatus 300 intended for the bait 330 to contact, and in a general instance, albeit not necessary, the bait 330 may receive some stability (such as by way of support) from such contact. However, the configuration of the bait platform 318 is not meant to be limited by the term. Thus, the bait platform 318 may be comparable or identical in configuration (e.g., thickness, material, etc.) as the rest of the second segment 342. As shown in the Figures, the bait platform 318 may be part of the second segment 342 that is between the second arcuate 315 and the coupler zone 302.

Still, the bait platform 318 may take on a number of configurations that differentiate the bait platform 318 from the rest of the second segment 342. For example, the bait platform 318 may have a difference in thickness from the second segment 342. The bait platform 318 may have a partially flat surface.

In embodiments, the bait platform 318 may be engaged with the bait end 310 in the first position 322. In embodiments, the bait platform 318 may be disengaged with the bait end 318 in the second position 324. The bait platform 318 may be defined by a planar (e.g., planar reference) 357. In this sense, at least a portion 310A of the bait end 310 may reside on a first side 357A of the planar 357 in the first position 322. Relatedly, the entire bait end 310 may reside on a second side 357B of the planar 357 in the second position 324.

The bait end 310 may include a protrusion 312 disposed thereon or associated therewith. In some embodiments, the protrusion 312 may be rounded, such as spherical, ovular, elliptical, etc., while in other embodiments the protrusion 312 may be partially rounded, such as partially spherical, partially ovular, etc. The protrusion 312 may be slightly rounded, slightly flattened, and combinations thereof.

The bait end 310 and/or protrusion 312 may include a barb. In embodiments, the protrusion 312 may include a bait end barb 319. The protrusion 312 may provide a ‘cam’ action in conjunction with the bait 330. That is, in some embodiments, the protrusion 312 may be inserted, such as orally, into the bait 330, and then the bait 330 and/or the apparatus 300 may be turned or twisted, such that the orientation of the protrusion 312 in the bait 330 results in more tension and resistance that keeps the bait 330 thereon. For example, more tension may be applied against the roof and lower part of the bait mouth, and while possibly uncomfortable, the tension force is hardly fatal.

The bait platform 318 may include a channel (or notch, groove, depression, etc.) 316 configured to engage with the protrusion 312, such as in the first position 322. The channel 316 may be movingly separable from the protrusion 312, such as when the apparatus 300 is moved to the second position 324 (e.g., see FIG. 3X). The second segment 342 may include a notch (e.g., channel, detent, groove, recess, etc.) 316. The notch may include an opening 316A. The notch 316 may be a narrow slot within the bait platform 318. The size of the notch 316 may be such that insertion of the protrusion 312 therein may occur.

The first segment 340 may include a first disconnect 358. The second segment 342 comprises a second disconnect 359. The first segment 340 may include a first bend 360. The second segment 342 may include a second bend 362. In embodiments, the first segment 340 and the second segment 342 may be configured to form or include a cross-over (or cross-over zone, cross-over region, etc.) 304.

The bait 330 may be attached to the bait end 310 with the protrusion 312 internal to the bait 330. In embodiments, the bait 330 may be attached to the bait end 310 by oral insertion of at least a portion of the bait end 310 into the bait 330. At least a portion 330A of the bait 330 may contact at least a corresponding portion 342A of the second segment 342.

FIGS. 3C-3G show various embodiments of an apparatus 300 configured with a cross-over that are apparent to one of skill in the art. For example, FIG. 3C shows a rounded protrusion 312 (which may be orally inserted into bait 330). FIG. 3D shows bait end 310 with an arcuate end 312A and protrusion 312.

FIGS. 3D and 3E illustrate the protrusion 312 on bait end 310 as having a linear (or not rounded) shape to it. The end of the protrusion 310A may engage the bait platform 318. FIG. 3E shows the bait platform may be configured with a notch or channel 316, to which the end 310A may rest therein. Such a configuration(s) may be provide for enhanced ability to maintain bait 330 thereon. FIG. 3H shows the bait platform 318 may be configured with a hole 316A, where the end 310A may pass therethrough. FIG. 3G illustrates the apparatus moved from the first position 322 to the second position 324, whereby the bait end 310A and the bait platform 318 may be disengaged or no longer proximate to each other.

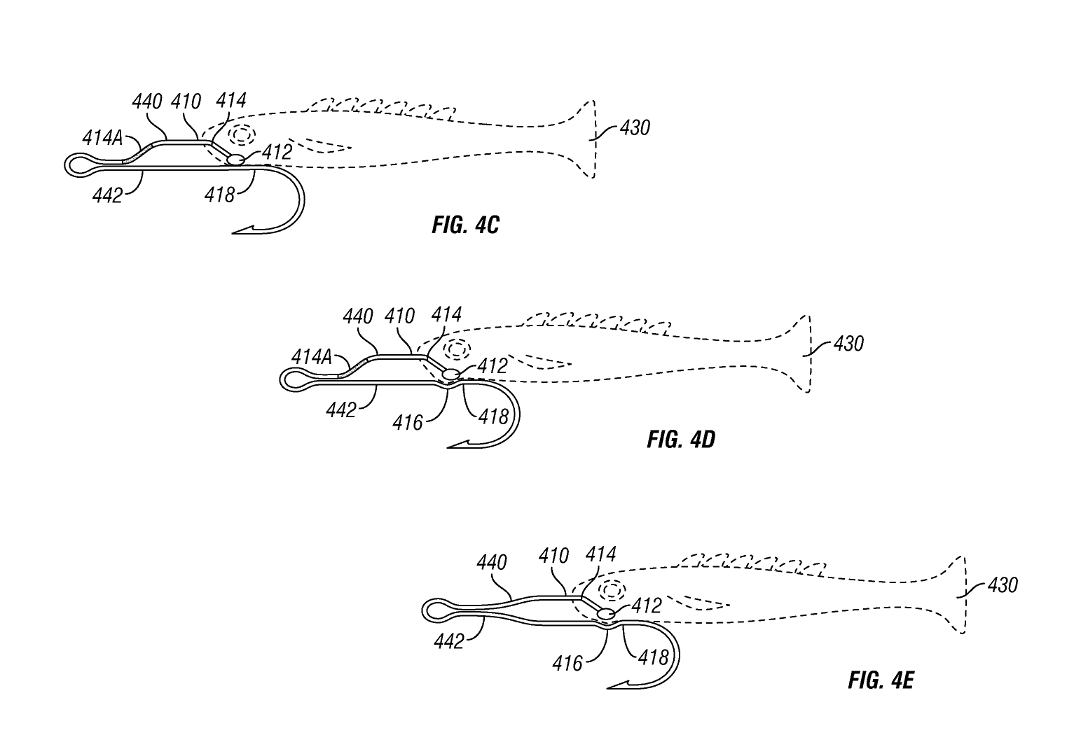

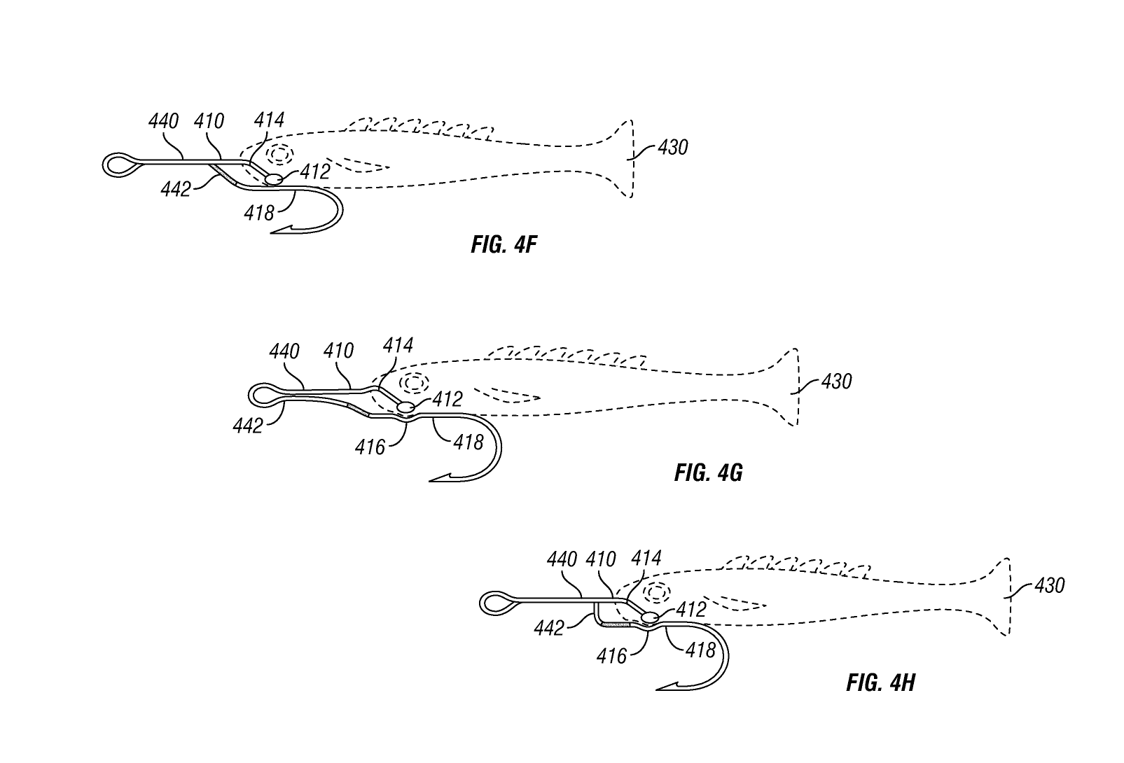

Referring now to FIGS. 4A, 4B, 4C, 4D, 4E, 4F, 4G, and 4H together, side views of a bait holder apparatus with a bait attached therewith, according to embodiments disclosed herein, are shown. Like the fish hook apparatuses (e.g., 200, 300) previously described, a bait holder apparatus 400 may be usable for aspects disclosed herein. As such, the bait holder apparatus 400 may include similar components and materials of construction as described previously, such that apparatus 400 may be similar to others described herein; however, apparatus 400 and others described herein are not necessarily identical.

The bait holder hook apparatus 400 of the present disclosure may include a coupler zone 402, which may be configured for coupling or attachment of the apparatus 400 with an external element (e.g., rod, reel, line, etc.). The coupler zone 402 may include an eyelet 402A or other suitable configuration for coupling. Embodiments of the disclosure may be used with any type of fishing equipment and/or any type of fishing line, and can be secured therewith in any suitable manner known in the art, and further usable with any type lure/bait.

In accordance with the disclosure, the bait 430 may be a live fish, such as a minnow(s), shad, etc. The bait 430 may be suitable for freshwater fishing, saltwater fishing, and/or both. An end 405A of the external element 405 may be fed through the coupler zone 402 and/or eyelet 402A, and then tied in a knot or other manner that results in secured coupling between the apparatus 400 and the external element 405. In embodiments, the eyelet 402A may be resultant or configured from a bias member, such as a spring coil. The bias member may be a spring coil, which may have a number of turns or wire wraps in the range of about 0 to about 10 turns.

The coupler zone 402 and/or other portions of the apparatus 400 may be flexible or otherwise movable. However, the coupler zone 402 and/or other portions of the apparatus 400 may be rigid, sturdy, and otherwise durable.

The apparatus 400 may include the first segment 440, which may be associated or linked with the coupler zone 402, and which may end or terminate in a bait end 410. The apparatus 400 may include the second segment 442, which may be associated or linked with the coupler zone 402 and/or the first segment 440. The second segment 442 may end or terminate in a hook end 406. The hook end 406 may include a barb 407.

The use of the barb 407 on the hook end 406 may help ensure fish have more difficulty (if not impossibility) from disengagement off the hook end 406. However, embodiments disclosed herein may include use of barbless hooks (mandatory in some fishing areas). The use of barbless hooks may allow an angler to easily remove the hook and release the fish without harming it, comply with regulations, etc.

The apparatus 400 may be made of or from any number of materials of construction. In this sense, any of the features or components of the apparatus 400 may be made of or from any number of materials of construction. The apparatus 400 may be a wire or wire material with a thickness or diameter in the range of about 0.02 to about 0.1 inches. However, the size, dimensions, etc. of the apparatus 400 are not meant to be limited, as the apparatus 400 may be different sizes, dimensions, etc. dependent upon whatever fishing endeavor is undertaken (be it fishing for 16′ sharks or 4″ perch), as the scale of which would be apparent to one of ordinary skill in the art.

Thus, the apparatus 400 may be formed of any suitable material and variously dimensioned consistent with the type of fish the apparatus 400 may be used to fish with. It is within the scope of the disclosure to utilize any type of fish hook end 406 configured for any type of fish, as would be apparent to one of skill in the art.

The scope of the disclosure is not limited to an apparatus that is of a single material. In embodiments, the bait end 410 may be a first material, and the hook end 406 may be a second material 254. In some embodiments, the first material and the second material may be the same, while in other embodiments the first material and the second material may be different.

Any of the materials may include, for example, rubber, metal, metal alloys, and so forth. The apparatus 400 may be made of resilient stainless steel wire or other comparable rustproof/rust-resistant material. The apparatus 400 may be constructed in a wide variety of scope of this disclosure. The apparatus may be made in accordance with manufacturing and/or fabrication processes described herein.

In accordance with the disclosure, the hook size, number of hooks, number of barbs, and style are not meant to be limited, other than as how claimed. Moreover, other configurations, such as a weedless configuration described herein, may be used. In some embodiments, the apparatus 400 may include a lure/spoon configuration, such as the lure and/or spoon configuration described herein.

In aspects, the apparatus 400, including its features and components, is a single, integral apparatus 400, such as entirely from the bait end 410 to the hook end 406. However, in other aspects, the apparatus may be a modular system, whereby various features and components are separable from one other, such as by threadable features, quick disconnects, insertions, and the like. For example, the bait end 410 may be removable (e.g., separable, etc.) from the apparatus 200 such that a second bait end may be switched therewith and connected to the apparatus 200. Thus, either of the segments 440, 442 may include an attachment mechanism (or comparable disconnect), such as an opening or hole, matable with a portion of the bait end 410 and/or hook end 406, respectively.

Thus, the apparatus 400 may utilize or otherwise be configured with variety of hook sizes such as those ranging in size from smaller fresh water trout hooks (or catfish hooks, bass hooks, pike hooks, etc.) to larger hook sizes suitable for catching saltwater fish such as cod, striped bass, marlin, shark, tuna, etc. In embodiments, the second segment 442 and/or hook end 406 may include at least a second hook end (not shown). In embodiments, the fish hook apparatus 400, and/or components thereof, may be colored. The apparatus 400 may include an adhesive disposed thereon as described herein.

The second segment 442 may include a bait platform 418 as described herein. ‘Platform’ in this sense is used to denote a part of the apparatus 400 intended (although not necessary) for the bait 430 to contact, and as a result, the bait 430 may receive some stability (such as by way of support) from such contact. However, the configuration of the bait platform 418 is not meant to be limited by the term. Thus, the bait platform 418 may be comparable or identical in configuration (e.g., thickness, material, etc.) as the rest of the second segment 442. As shown in the Figures, the bait platform 418 may be part of the second segment 442 that is between the second arcuate 415 and the coupler zone 402.

Still, the bait platform 418 may take on a number of configurations that differentiate the bait platform 418 from the rest of the second segment 442. For example, the bait platform 418 may have a difference in thickness from the second segment 442. The bait platform 418 may have a partially flat surface.

The bait end 410 and/or protrusion 412 may include a barb. In embodiments, the protrusion 212 may include a bait end barb. The protrusion 412 may provide a ‘cam’ action in conjunction with the bait 430. That is, in some embodiments, the protrusion 212 may be inserted orally to the bait 430, and then the bait 430 and/or the apparatus 400 may be turned or twisted, such that the orientation of the protrusion 412 in the bait 430 results in more tension and resistance that keeps the bait thereon. For example, more tension may be applied against the roof and lower part of the bait mouth, and while possibly uncomfortable, the tension force is hardly fatal. The protrusion 412 may be comparable or exact to the protrusion 212 described herein.

Thus, the protrusion 412 may be rounded, such as spherical, ovular, elliptical, etc., while in other embodiments the protrusion 412 may be partially rounded, such as partially spherical, partially ovular, etc. The protrusion 412 may be slightly rounded, slightly flattened, and combinations thereof. The protrusion 412 may have additional protrusions disposed thereon, including a barb.

The bait 430 may be attached to the bait end 410 with the protrusion 412 internal to the bait 430. In embodiments, the bait 430 may be attached to the bait end 410 by oral insertion of at least a portion of the bait end 410 into the bait 430. At least a portion 430A of the bait 430 may contact at least a corresponding portion 442A of the second segment 442. The hook end 406 and the bait end 410 may be biased toward each other.

FIGS. 4A-4H show various embodiments of an apparatus 400 that are apparent and understood to one of skill in the art. For example, FIG. 4A shows a linear bait end 310 configured with rounded protrusion 412 (which may be orally inserted into bait 330). FIG. 4B shows bait end 410 with an arcuate end 414 and protrusion 412.

FIG. 4C illustrates the segment 440 may include arcuates 414, 414A, and segment 442 is generally linear. FIG. 4D is comparable to 4C, except the segment 442 (or bait platform 418) includes a notch or channel 416. In an embodiment, the end of the bait end 410A and/or the protrusion 412 may rest or otherwise engage with or proximate to the region of the notch/channel 416. FIG. 4E illustrates the first and second segments 440, 442 configured with non-linear regions. In this sense the apparatus 400 is a uniform, continuous piece all the way from barb 407 to protrusion 412. FIGS. 4F, 4G, and 4H are similar in nature with apparent differences in features.

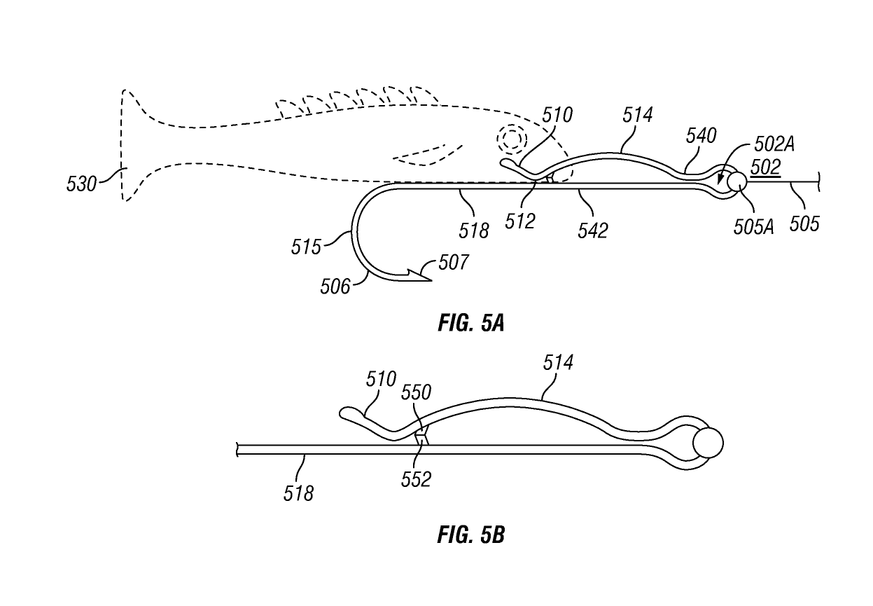

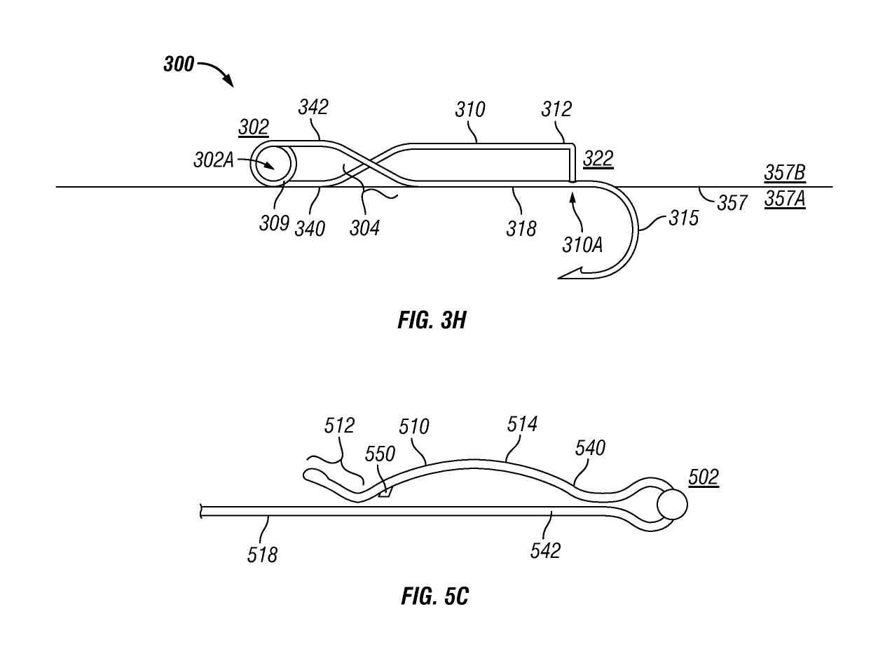

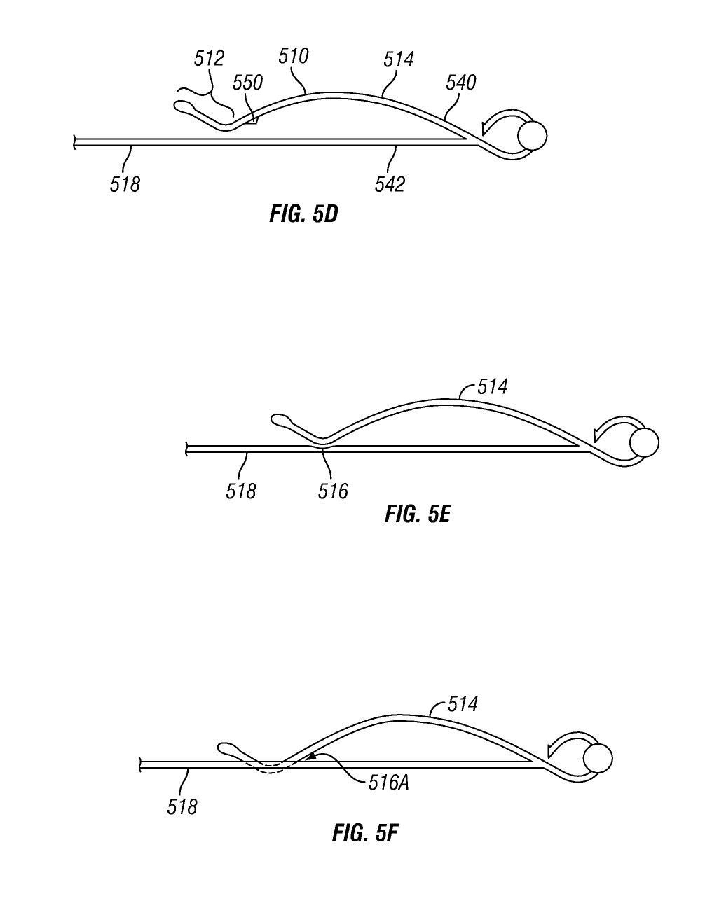

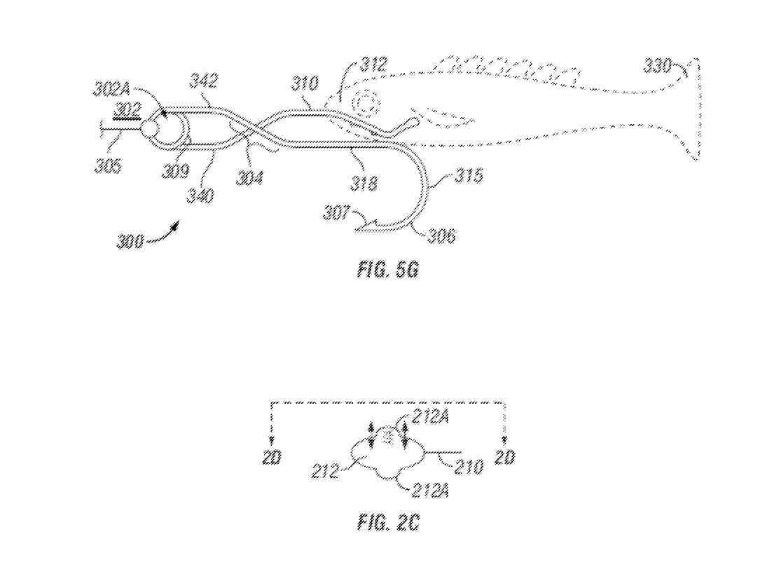

Referring now to FIGS. 5A, 5B, 5C, 5D, 5E, 5F, and 5G, various views of a bait holder apparatus 500 configurable with a protrusion feature 550, according to embodiments disclosed herein, are shown. In the general sense, the bait holder hook apparatus 500 of the present disclosure may include a coupler zone 502, which may be configured for coupling the apparatus 500 with an external element 505, such as a fishing line, a leader, etc.

Like the fish hook apparatuses previously described, a bait holder apparatus 500 may be usable for aspects disclosed herein. As such, the fish hook apparatus 500 may include similar components and materials of construction as described herein, such that apparatus 500 may be similar to others described herein; however, apparatus 500 and others described herein are not necessarily identical.

The coupler zone 502 may include an eyelet 502A or other suitable configuration for coupling. The external element 505 may be, for example, a leader, a fishing line, and combinations thereof. Embodiments of the disclosure may be used with any type of fishing equipment and/or any type of fishing line, and can be secured therewith in any suitable manner known in the art, and further usable with any type lure/bait.

In accordance with the disclosure, the bait 530 may be a live fish, such as a minnow(s), shad, etc. The bait 530 may be suitable for freshwater fishing, saltwater fishing, and/or both. An end 505A of the external element 505 may be fed through the coupler zone 402 and/or eyelet 502A, and then tied in a knot or other manner that results in coupling between the apparatus 500 and the external element 505. In embodiments, the eyelet 502A may be resultant or configured from a bias member, such as a spring coil. The bias member may be a spring coil, which may have a number of turns or wire wraps in the range of about 0 to about 10 turns.

The coupler zone 502 and/or other portions of the apparatus 500 may be flexible or otherwise movable. However, the coupler zone 502 and/or other portions of the apparatus 500 may be rigid, sturdy, and otherwise durable.

The apparatus 500 may include the first segment 540, which may be associated or linked with the coupler zone 502, and which may end or terminate in a bait end 510. The apparatus 500 may include the second segment 542, which may be associated or linked with the coupler zone 502 and/or the first segment 540. The second segment 542 may end or terminate in a hook end 506. The hook end 506 may include a barb 507.

The use of the barb 507 on the hook end 506 may help ensure caught fish have more difficulty (if not impossibility) from disengagement off the hook end 506. However, embodiments disclosed herein may include use of barbless hooks (mandatory in some fishing areas). The use of barbless hooks may allow an angler to easily remove the hook and release the fish without harming it, comply with regulations, etc.

The apparatus 500 may be made of or from any number of materials of construction. In this sense, any of the features or components of the apparatus 500 may be made of or from any number of materials of construction. The apparatus 500 may be a wire or wire material with a thickness or diameter in the range of about 0.02 to about 0.1 inches. However, the size, dimensions, etc. of the apparatus 500 are not meant to be limited, as the apparatus 500 may be different sizes, dimensions, etc. dependent upon whatever fishing endeavor is undertaken (be it fishing for 16′ sharks or 4″ perch), as the scale of which would be apparent to one of ordinary skill in the art.

Thus, the apparatus 500 may be formed of any suitable material and variously dimensioned consistent with the type of fish the apparatus 500 may be used to fish with. It is within the scope of the disclosure to utilize any type of fish hook end 506 configured for any type of fish, as would be apparent to one of skill in the art.

The scope of the disclosure is not limited to an apparatus that is of a single material. In embodiments, the bait end 510 may be a first material, and the hook end 506 may be a second material. In some embodiments, the first material and the second material may be the same, while in other embodiments the first material and the second material may be different.

Any of the materials may include, for example, rubber, metal, metal alloys, and so forth. The apparatus 500 may be made of resilient stainless steel wire or other comparable rustproof/rust-resistant material. The apparatus 500 may be constructed in a wide variety of sizes for use with various bait when seeking particular target fish without departing from the scope of this disclosure. The apparatus may be made in accordance with manufacturing and/or fabrication processes described herein.

In accordance with the disclosure, the hook size, number of hooks, number of barbs, and style are not meant to be limited, other than as how claimed. Moreover, other configurations, such as a weedless configuration described herein, may be used. In some embodiments, the apparatus 500 may include a lure/spoon configuration, such as the lure and/or spoon configuration described herein.

In aspects, the apparatus 500, including its features and components, is a single, integral apparatus 500, such as entirely from the bait end 510 to the hook end 506. However, in other aspects, the apparatus may be a modular system, whereby various features and components are separable from one other, such as by threadable features, quick disconnects, insertions, and the like. For example, the bait end 510 may be removable (e.g., separable, etc.) from the apparatus 500 such that a second bait end may be switched therewith and connected to the apparatus 500. Thus, either of the segments 540, 542 may include an attachment mechanism (or comparable disconnect), such as an opening or hole, matable with a portion of the bait end 510 and/or hook end 506, respectively.

Thus, the apparatus 500 may utilize or otherwise be configured with variety of hook sizes such as those ranging in size from smaller fresh water trout hooks (or catfish hooks, bass hooks, pike hooks, etc.) to larger hook sizes suitable for catching saltwater fish such as cod, striped bass, marlin, shark, tuna, etc. In embodiments, the second segment 542 and/or hook end 506 may include at least a second hook end (not shown). In embodiments, the fish hook apparatus 500, and/or components thereof, may be colored. The apparatus 500 may include an adhesive disposed thereon as described herein.

The first segment 540 may include a first arcuate 514. The second segment 542 may include a bait platform 518 as described herein. ‘Platform’ in this sense is used to denote a part of the apparatus 500 intended (although not necessary) for the bait 530 to contact, and as a result, the bait 530 may receive some stability (such as by way of support) from such contact. However, the configuration of the bait platform 518 is not meant to be limited by the term. Thus, the bait platform 518 may be comparable or identical in configuration (e.g., thickness, material, etc.) as the rest of the second segment 542. As shown in the Figures, the bait platform 518 may be part of the second segment 542 that is between the second arcuate 515 and the coupler zone 502.

Still, the bait platform 518 may take on a number of configurations that differentiate the bait platform 518 from the rest of the second segment 542. For example, the bait platform 518 may have a difference in thickness from the second segment 542. The bait platform 518 may have a partially flat surface.

The bait end 510 and/or protrusion 512 may include a barb. In embodiments, the protrusion 512 may include a bait end barb. The protrusion 512 may provide a ‘cam’ action in conjunction with the bait 530. In other embodiments, the bait end 510 and/or protrusion 512 may operate like a clip-clasp.

As such, the bait end 510 may be inserted orally to the bait 530, whereby the orientation of the bait end 510 in the bait 530 may result in tension and resistance that keeps the bait 530 secured with the apparatus 500. The protrusion 512 may be rounded, such as spherical, ovular, elliptical, etc., while in other embodiments the protrusion 512 may be partially rounded, such as partially spherical, partially ovular, etc. The protrusion 512 may be slightly rounded, slightly flattened, and combinations thereof. The protrusion 512 may have additional protrusions disposed thereon, including a barb.

In any of the embodiments disclosed herein, and as illustrated with FIGS. 5A-5G, the apparatus may include a protrusion feature 550 on the bait end 530. The protrusion feature 550 may be configured for engagement with a corresponding feature 552 disposed on the hook end 506 (or bait platform 518, segment 542, etc.). FIG. 5A illustrates the protrusion 550 on the inside of the bait, while feature 552 is on the outside. Such an arrangement may provide additional securement ability for maintaining bait 530 on the apparatus 500, which is especially useful for trolling or when reeling in. FIG. 5B is a close-up of the features. FIG. 5C illustrates there may only be a single feature 550 (or alternatively just 552).

FIGS. 5D-5F show a variant of the coupler 502, which may just be a terminus loop end. Such end may be formed by, for example, a fishing tool, needle nose, etc. The coupler end 502 may then lead to a branch of the first and second segments 540, 542, respectively. FIG. 5E illustrates how the second segment may be configured with a notch or channel 516. FIG. 5F illustrates how the second segment may be configured with a hole 516 whereby part of the first segment may readily fit in or pass therethrough. FIG. 5G illustrates a cross-over region variation which may be included with protrusion end 550.

The bait 530 may be attached to the bait end 510 with the protrusion 512 internal to the bait 530. In embodiments, the bait 530 may be attached to the bait end 510 by oral insertion of at least a portion of the bait end 510 into the bait 530. At least a portion 530A of the bait 530 may contact at least a corresponding portion 542A of the second segment 542. The hook end 506 and the bait end 510 may be biased toward each other. The bait end 510 may be biased toward the hook end 506 and/or second segment 542, and/or vice versa.

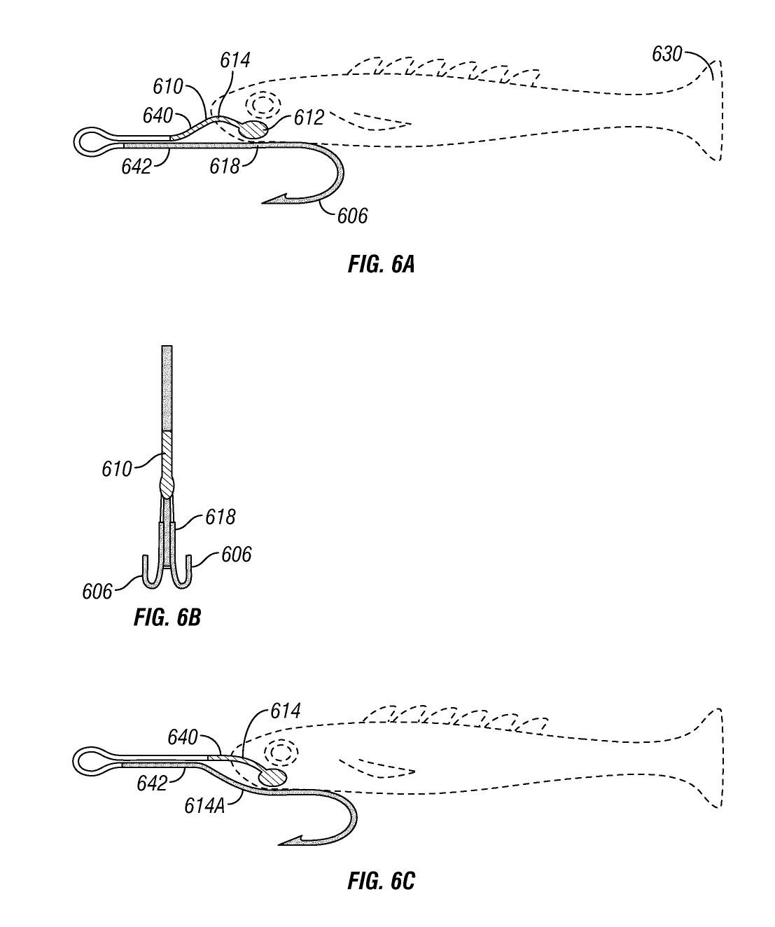

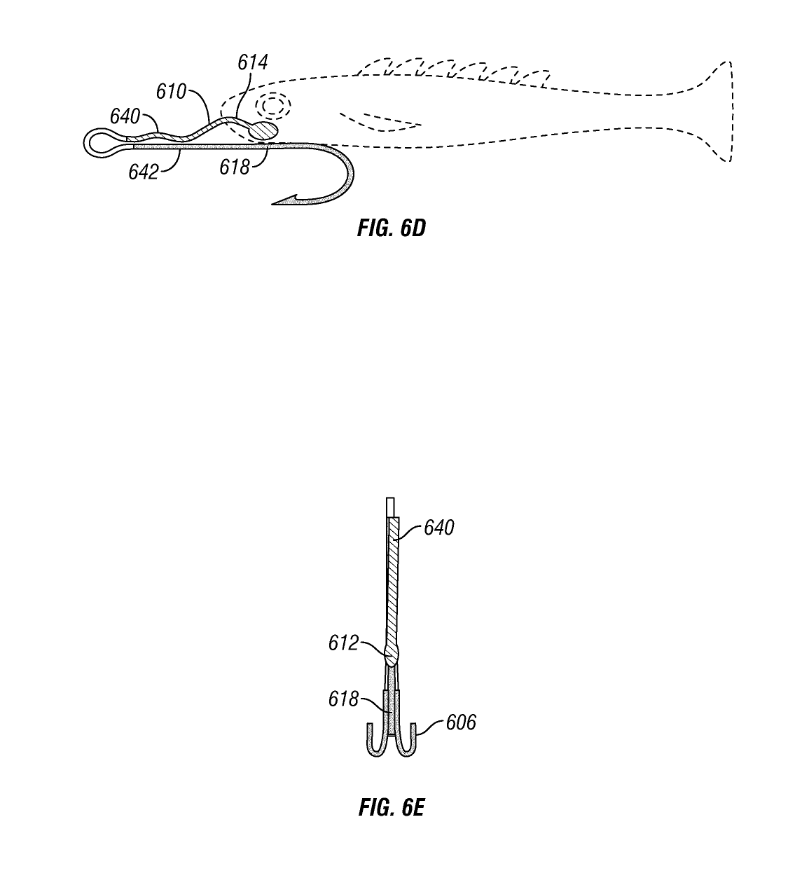

Referring now to FIGS. 6A, 6B, 6C, 6D, and 6E, various views of a bait holder apparatus having a dual hook end 606 configuration, according to embodiments disclosed herein, is shown. Like the fish hook apparatuses previously described, a bait holder apparatus 600 may be usable for aspects disclosed herein. As such, the fish hook apparatus 600 may include similar components and materials of construction as described herein, such that apparatus 600 may be similar to others described herein, and for brevity such aspects will not be discussed; however, apparatus 600 and others described herein are not necessarily identical.

The coupler zone 602 may include an eyelet 602A or other suitable configuration for coupling. The external element may be, for example, a leader, a fishing line, and combinations thereof. Embodiments of the disclosure may be used with any type of fishing equipment and/or any type of fishing line, and can be secured therewith in any suitable manner known in the art, and further usable with any type lure/bait. In accordance with the disclosure, the bait 630 may be a live fish, such as a minnow(s), shad, etc. The bait 630 may be suitable for freshwater fishing, saltwater fishing, and/or both. The coupler zone 602 and/or other portions of the apparatus 600 may be flexible or otherwise movable. However, the coupler zone 602 and/or other portions of the apparatus 600 may be rigid, sturdy, and otherwise durable.

The apparatus 600 may include the first segment 640, which may be associated or linked with the coupler zone 602, and which may end or terminate in a bait end 610. The apparatus 600 may include the second segment 642, which may be associated or linked with the coupler zone 602 and/or the first segment 640. The second segment 642 may end or terminate in a dual hook end 606 configuration. The hook ends 606 may include a barb(s) 607.

The first segment 640 may include a first arcuate 614. The second segment 642 may include a bait platform 618 as described herein. ‘Platform’ in this sense is used to denote a part of the apparatus 600 intended (although not necessary) for the bait 630 to contact, and as a result, the bait 630 may receive some stability (such as by way of support) from such contact. However, the configuration of the bait platform 618 is not meant to be limited by the term. Thus, the bait platform 618 may be comparable or identical in configuration (e.g., thickness, material, etc.) as the rest of the second segment 642. As shown in the Figures, the bait platform 618 may be part of the second segment 642 that is between the second arcuate 615 and the coupler zone 602.

Still, the bait platform 618 may take on a number of configurations that differentiate the bait platform 618 from the rest of the second segment 642. For example, the bait platform 618 may have a difference in thickness from the second segment 642. The bait platform 618 may have a partially flat surface.

The improved bait holder apparatus of the disclosure may provide for bait attachment to the apparatus quickly and securely in a manner that does not impair or kill the bait. Embodiments disclosed herein may provide for expedient change or replacement of apparatus components. Aspects of the disclosure may provide for a bait holder hook that is extremely simple and inexpensive means for use with bait, without killing or even harming the bait while attaching the bait thereto. The apparatus beneficially promotes movement of live bait in its natural motion, thus being completely attractive to lure game fish. The combination of a bait holder and fish hook provides for easy insertion of the apparatus into the mouth of live bait without harm or injury.

Other benefits of the disclosure include a bait more readily coupled to the apparatus in a secure manner that does not cause impairment as the bait need not be impaled, yet the apparatus may prevent the fish from “stealing” bait off of the hook.

Benefits of the disclosure may include kids, experienced, non-experienced fishermen, etc. to enjoy the sport of fishing without the problems associated with impaling bait. Moreover, the bait may be quickly, easily, and more safely attached to hook. Embodiments disclosed herein may be useful for live or artificial bait applications. No injury results to the bait, such that the bait will have sufficient freedom of movement, without the possibility of escape, and the bait will be more attractive to the fish that are being sought.

While the present disclosure has been described with respect to a limited number of embodiments, those skilled in the art, having benefit of the present disclosure will appreciate that other embodiments may be devised which do not depart from the scope of the disclosure described herein. Accordingly, the scope of the disclosure should be limited only by the claims appended hereto.

What is claimed is:

1. A bait holder hook apparatus comprising:
a coupler zone configured to couple the apparatus with an external element;
a first segment linked with the coupler zone, and ending in a bait end; and
a second segment associated with the first segment, and ending in a hook end.

2. The apparatus of claim 1, wherein the coupler zone comprises an eyelet that is part of a coil spring.

3. The apparatus of claim 1, wherein the first segment comprises a first elongated portion, and wherein the second segment comprises a second elongated portion and a second arcuate portion.

4. The apparatus of claim 3, wherein at least one of the first segment, the second segment, and combinations thereof, is biased toward a first position.

5. The apparatus of claim 4, wherein the first position comprises a first contact point of the first segment engaged with a second contact point of the second segment.

6. The apparatus of claim 1, wherein the bait end comprises a protrusion.

7. The apparatus of claim 6, the apparatus further comprising a bait platform, wherein the protrusion is rounded.

8. The apparatus of claim 7, wherein the bait platform comprises one of a channel and a notch configured to engage with the protrusion in the first position.

9. The apparatus of claim 1, wherein the first segment comprises a first bend, wherein the second segment comprises a second bend, and wherein the first segment and the second segment are configured to form a cross-over.

10. The apparatus of claim 1, wherein the coupler zone comprises a coil spring of at least 2 turns, wherein a first spring end links to the first segment, and wherein a second spring end links to the second segment.

11. The apparatus of claim 1, wherein a live bait is attached to the bait end.

12. The apparatus of claim 1, wherein the hook end and the bait end are biased toward each other.

13. A method of baiting a fish hook apparatus, the method comprising:
coupling the fish hook apparatus to a fish line, the fish hook apparatus comprising:
a first segment ending in a bait end; and
a second segment ending in a hook end; and
attaching a live bait to the bait end.

14. The method of claim 13, the method comprising:
pressing a first portion of the first segment and a second portion of the second segment together in order to move the apparatus from a first position to a second position.

15. The method of claim 14, wherein the live bait is attached to the bait end when the apparatus is in the second position.

16. A fishing system comprising:
a fishing rod comprising a fishing line, and configured for casting the fishing line a fish hook apparatus comprising:
a coupler zone configured to couple the apparatus with the fishing line;
a first segment linked with the coupler zone, and ending in a bait end; and
a second segment associated with the first segment, and ending in a hook end.
a live bait attached to the bait end.

17. The system of claim 16, wherein the first segment comprises a first elongated portion, and wherein the second segment comprises a second elongated portion and a second arcuate portion.

18. The system of claim 16, wherein at least one of the first segment, the second segment, and combinations thereof, is biased toward a first position.

19. The system of claim 16, wherein the first position comprises a first contact point of the first segment engaged with a second contact point of the second segment.

20. The system of claim 16, wherein the bait end comprises a protrusion, and wherein the bait is attached to the bait end with a bait end protrusion internal of the bait.
